(19) United States
(12) Patent Application Publication
(10) Pub. No.: US 2017/0043737 A1
(43) Pub. Date: Feb. 16, 2017

(54) VEHICLE HEADLINER AND METHOD OF FORMING THE SAME

(71) Applicant: FORD GLOBAL TECHNOLOGIES, LLC, Dearborn, MI (US)

(72) Inventors: Kim Jin, Nanjing (CN); Tom Xu, Nanjing (CN); Kevin Shen, Nanjing (CN)

(21) Appl. No.: 15/228,794

(22) Filed: Aug. 4, 2016

(30) Foreign Application Priority Data
Aug. 11, 2015 (CN) 201510491231.1

(51) Int. Cl. B60R 21/214; B60R 13/02; B60R 21/232; B62D 25/06

(52) U.S. Cl. CPC B60R 21/214; B62D 25/06; B60R 13/0212; B60R 21/232; B60Y 2410/12

(57) ABSTRACT

One or more embodiments provide a vehicle headliner including a roof panel positioned between left and right side panels, at least one of the left and right side panels including a transverse-strength-weakened area extending along a vehicle longitudinal direction and interfacing a vehicle pillar along a vehicle width direction at an assembled position.

### RELATED APPLICATION(S)

This application claims the benefit of Chinese New Invention Patent Application No.: CN201510491231.1, filed on Aug. 11, 2015, the entire contents thereof being incorporated herein by reference.

### TECHNICAL FIELD

The disclosed relates generally to a vehicle headliner and a method of forming the same.

### BACKGROUND

Vehicle headliners often have areas interfacing interior trims such as pillar trims or nearby windows, particularly the area interfacing a B pillar and/or a C pillar trim and its nearby windows. In such an area, especially the area where a side curtain airbag may be present for deployment, edges of the headliner may affect the deployment of the side curtain airbag. There have been various solutions proposed in the art to improve the deployment of the side curtain airbag.

For instance, U.S. Pat. No. 6,848,711 discloses a vehicular passenger protecting apparatus including an airbag, a pillar portion of the vehicle, a trim member for covering the pillar portion with a gap formed between the trim member and the pillar portion, and a seal member for covering the gap.

For instance also, U.S. Pat. No. 6,142,506 discloses an energy absorbing vehicle trim, including an inflatable restraint, a trim piece, where the trim piece is to move from a covering position covering the inflatable restraint and to a deployed position so as to partially deflect from the vehicle body structure to allow the inflatable restraint to inflate along the surfaces adjacent the vehicle body structure.

### SUMMARY

According to one aspect, a vehicle headliner is provided to include a roof panel positioned between left and right side panels, at least one of the left and right side panels including a transverse-strength-weakened area extending along a vehicle longitudinal direction and interfacing a vehicle pillar along a width direction of vehicle at an assembled position.

According to another aspect, a method of forming a vehicle headliner is provided, the method including: providing a starter headliner including a roof panel positioned between left and right starter side panels with at least one of which including a substrate layer; and forming a transverse-strength-weakened area on the substrate layer of at least one of the left and right starter side panels, the transverse-strength-weakened area extending along a longitudinal direction and interfacing a vehicle pillar at an assembled position.

According to yet another aspect, a vehicle airbag restraint system is provided, the system including a headliner and an airbag at least partially positioned therein, the headliner including a roof panel positioned between left and right side panels, at least one of the left and right side panels including a transverse-strength-weakened area extending along a vehicle longitudinal direction and interfacing a vehicle pillar along a vehicle width direction at an assembled position.

One or more advantageous features as described herein are believed to be readily apparent from the following detailed description of one or more embodiments when taken in connection with the accompanying drawings.

### BRIEF DESCRIPTION OF THE DRAWINGS

Reference is now made to the one or more embodiments illustrated in greater detail in the accompanying drawings and described below wherein:

FIG. 1 illustratively depicts a headliner according to one or more embodiments;

FIG. 2 illustratively depicts a partially enlarged top view of the headliner referenced in FIG. 1;

FIG. 3A illustratively depicts a cross-sectional view of the vehicle headliner referenced in FIG. 2, taken along line 3A-3A;

FIG. 3B illustratively depicts an alternative view of the vehicle headliner referenced in FIG. 3A;

FIG. 4A illustratively depicts a partially enlarged view of the vehicle headliner referenced in FIG. 2;

FIG. 4B illustratively depicts another partially enlarged view of the vehicle headliner referenced in FIG. 2;

FIG. 5 illustratively depicts an exemplary method of forming the vehicle headliner referenced in FIG. 1 through FIG. 4B;

FIG. 6A illustratively depicts a starter side panel suitable to form a portion of the vehicle headliner referenced in FIG. 1 through FIG. 5;

FIG. 6B illustratively depicts another starter side panel suitable to form another portion of the vehicle headliner referenced in FIG. 1 through FIG. 5; and

FIG. 7 illustratively depicts a side or front view of a knifing tool suitable to form a transverse-strength-weakened area on the vehicle headliner referenced in FIG. 1.

### DETAILED DESCRIPTION OF ONE OR MORE EMBODIMENTS

As referenced in the FIG.s, the same reference numerals may be used herein to refer to the same parameters and components or their similar modifications and alternatives. These parameters and components are included as examples and are not meant to be limiting. The drawings referenced herein are schematic and associated views thereof are not necessarily drawn to scale.

Vehicle safety is an important consideration for automobile manufacturers. As a restraint device, side curtain airbags may require some special design consideration to ensure desirable deployment performance. Special attention may be given to certain areas such as edges of the headliner and the interior trim of the pillars to avoid unwanted interference from these areas in airbag deployment.

The present embodiments are advantageous at least in reflecting the awareness that these above-mentioned areas may be provided with certain airbag guiding structures or be provided with a headliner and/or its associated pillar trim of relatively reduced width along a vehicle width direction to avoid unwanted interference in airbag deployment. On the other hand, the headliner may need to be configured to accommodate various design parameters associated with various vehicle models such as four door sedan models and five door hatchback models, where interfacing designs between the side curtain airbag and the headliner may often be different if not always. For instance, side curtain airbag deployment path in a four door sedan may correspond to an area in a five door hatchback where a side window is to contact a seal with particular sealing requirements. Therefore merely adjusting and in particular narrowing the headliner width along the vehicle width direction may be helpful in one vehicle type and not in another. This is particularly true where the interfacing areas may involve the need for the seal or window seal, because too narrow of an edge of the headliner may not provide ample support for the seal to be properly seated and may result in premature disengagement.

Accordingly, the inventors have recognized one or more issues mentioned herein above and have provided a vehicle headliner and its corresponding forming method in one or more embodiments, where the vehicle headliner as provided may be employed as a universal headliner with relatively reduced cost and complexity and to meet certain curtain airbag deployment requirements as well as to facilitate the seating of an associated seal member. One or more embodiments will further be described in view of the accompany drawings.

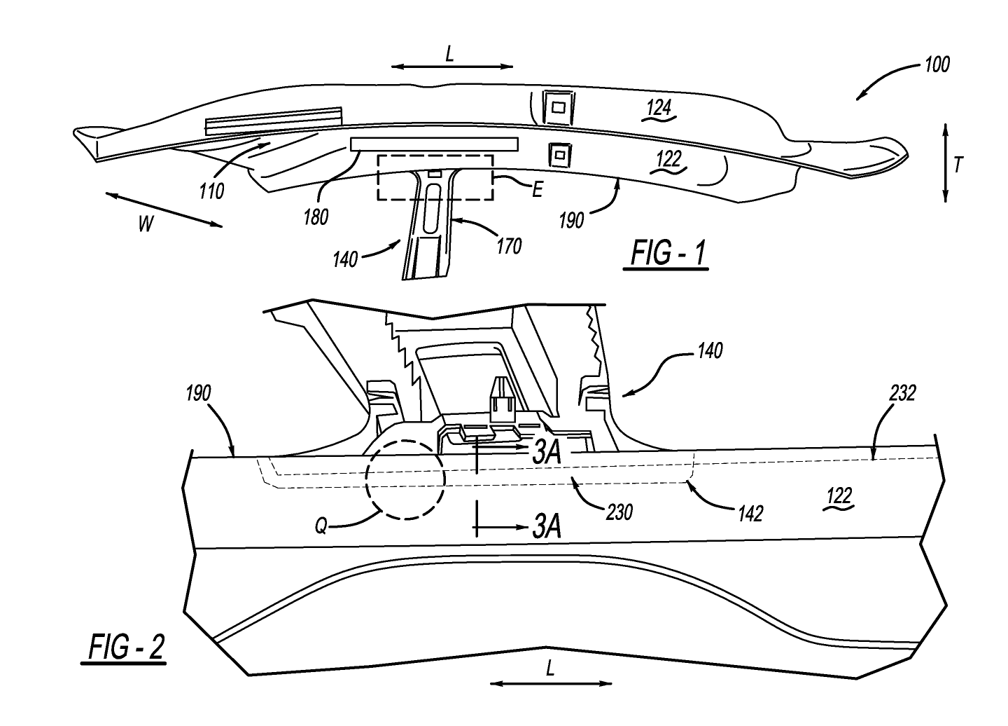

FIG. 1 in view of FIG. 2 illustratively depicts a vehicle headliner 100 of one or more embodiments, where the vehicle headliner 100 extends in a vehicle longitudinal direction L, that is along the length direction of the vehicle (not shown). In a width direction W of the vehicle such as a direction perpendicular to the longitudinal direction L, the vehicle headliner 100 may include a roof panel 110 positioned between a left side panel 124 and a right side panel 122. The right side panel 122 as depicted in FIG. 1 includes a transverse-strength-weakened area 230 extending along the vehicle longitudinal direction L and interfacing a vehicle pillar 140 along the vehicle width direction at an assembled position. In certain embodiments, the transverse-strength-weakened area 230 may be in contact with a vehicle pillar trim 170 which at least partially encloses therein the vehicle pillar 140.

In one or more embodiments, the term “transverse strength” or alternatively “resistance strength” may be determined or assessed by the test method for determining stiffness or modulus of bending of interior trim materials and substrates according to protocol J949 of the Society of Automotive Engineers (SAE). Modulus of bending is believed to be in proportion to or as a function of the transverse strength. In one or more embodiments, modulus of bending of the intentionally formed transverse-strength-weakened area 230 is smaller relative to that of the other regions of the vehicle headliner 100 such as its left and right side panels 124,122 under the same test conditions such as under room temperature and/or atmospheric air pressure. Of course, any suitable methods other than the above-mentioned protocol J949 of SAE may be used for the purpose of comparatively locating or determining the existence of a transverse-strength-weakened area such as the transverse-strength-weakened area 230 mentioned herein. As a rule of thumb, the transverse-strength-weakened area 230 is more easily and readily to bend and/or break in comparison to the other areas of the right side panel 122 upon an impact which would often trigger a curtain airbag such as side curtain airbag 180 of FIG. 1 to deploy. This exemplary method provides a non-limiting method of determining whether an area has indeed been created with transverse-strength relatively weakened.

Referring back to FIG. 1, there are no particular restrictions as to whether, how or where the left side panel 124 and the right side panel 122 are differentiated from the roof panel 110 as long as the left side panel 124 is adjacent to or abutting the roof panel 110 of the vehicle headliner 100 and the right side panel 122 is similarly adjacent to or abutting the roof panel 110 of the vehicle headliner 100. In other words, the left and right side panels 124, 122 each are in material continuity with and adjacent to or abutting the roof panel 110. Accordingly the left and right side panels 124, 122 may be relatively closer in position to the side window than the roof panel 110 and may be positioned with an angle relative to the roof panel 110.

Although FIG. 1 only depicts the right side panel 122 interfacing a vehicle pillar 140 or a vehicle pillar trim 170, it is appreciated that the left side panel 124 may employ a similar design. For brevity, embodiments of the present invention herein and elsewhere are described in the context of the area where the right side panel 122 interfaces the vehicle pillar trim 170. However it is noted that these descriptions are equally applicable to the other parts that are not shown, for instance the area where the left side panel 124 and pillar trim (not shown) interfaces each other. The vehicle pillar 140 may be any suitable pillars of the vehicle, for instance, the B pillar and the C pillar.

One or more embodiments detailing the structure of the vehicle headliner 100 will be discussed further in view of the drawings FIG. 2 through FIG. 4B.

FIG. 2 illustratively depicts a partially enlarged top view of the vehicle headliner 100 referenced in FIG. 1, in particular a top view of an area marked as a box E in broken line indicated in FIG. 1 along the longitudinal direction L. The vehicle pillar trim 140 interfaces the edge 190 of the right side panel 122 of the vehicle headliner 100. It is appreciated that, vehicle pillar trim 170 may be attached to a vehicle pillar such as the B pillar via any suitable techniques such as a snap-in connection. In the current example, at least a portion of the edge 190 of the vehicle headliner 100 interfaces the vehicle pillar trim 170. The term “interface” may refer to that the edge 190 and the vehicle pillar trim 170 overlap along certain direction, for instance, the edge 142 of the vehicle pillar trim 170 is shown to overlap partially with the edge 190 of the vehicle headliner 100 along a height direction T of the vehicle. It is noted that the edge 142 of the vehicle pillar trim 170 may partially overlap the edge 190 of the vehicle headliner 100 along other directions.

To satisfy deployment requirements of the side curtain airbag 180, one solution as mentioned herein elsewhere may be to decrease the edge width of the vehicle headliner 100 along the vehicle width direction W so as to make room and clear path for deployment of the side curtain airbag 180. In other words, a possible solution is to decrease dimension of an overlapped area between the edge 190 of the right side panel 122 and the vehicle pillar trim 170, or to decrease the dimension of the right side panel 122 along the vehicle width direction W. However, such an operation may be difficult during manufacturing and as mentioned herein above, the vehicle headliner 100 may have various designs dependent upon a particular location of the side curtain airbag and therefore the headliners involved may not be universal.

Referring back to FIG. 1, the transverse-strength-weakened area 230 extends along the longitudinal direction L on the right side panel 122 of the vehicle headliner 100, and the transverse-strength-weakened area 230 interfaces the vehicle pillar trim 170 at an assembled position such as after being installed onto the vehicle. Accordingly the right side panel 122 does not need to be subjected to various width alterations along the longitudinal direction L, which may be labor intensive and may also be prone to unnecessary errors. The right side panel 122 along with the roof panel 110 and the left side panel 124 may be constructed in any suitable manner, and the transverse-strength-weakened area 230 may be imparted onto the right side panel 122 before the vehicle headliner 100 is finalized. In relation to the description relative to the right side panel 122, the left side panel 124 may adopt a similar configuration.

In another one or more embodiments, the transverse-strength-weakened area 230 generally extends along the vehicle longitudinal direction L and forms an extended area 232 that is beyond the vehicle pillar trim 170. In other words, the dimension of the transverse-strength-weakened area 230 is greater than the width of the vehicle pillar 140 and/or vehicle pillar trim 170 along the longitudinal direction L. This configuration is believed to be advantageous in conditioning the extended area 232 of the right side panel 122 particularly ready for accommodating a deployment of the side curtain airbag 180 and allowing deployed air to enter through the extended area 232 to be protective of an occupant.

The transverse-strength-weakened area 230 mentioned herein or elsewhere as well as the dimension of its extended area 232 may be adjusted as necessary, taking into consideration of various deployment positions of the side curtain airbag 180, so as to form the transverse-strength-weakened area 230 universal or one-size-fits-all that may be suitable to accommodate different vehicle models. In addition, the transverse-strength-weakened area 230 may be configured to include two or more separate portions to interface the B pillar and the C pillar, respectively.

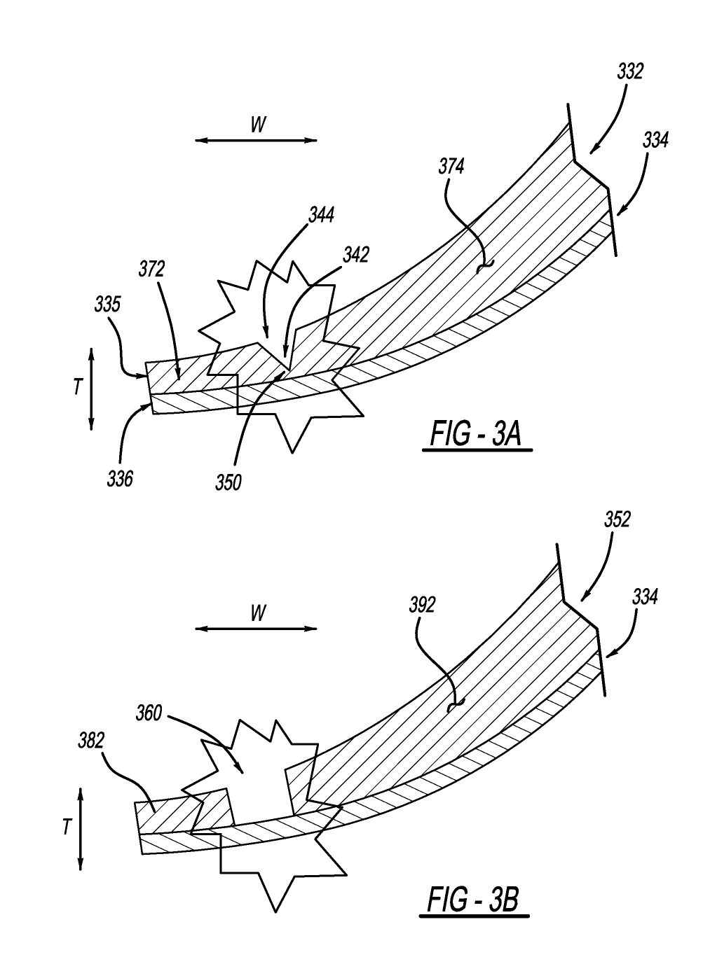

Referring back again to FIG. 2 and further in view of FIG. 3A-3B, features of the transverse-strength-weakened area 230 are discussed in more details. FIG. 3A and 3B illustratively depict a cross-sectional view along line 3A-3A of the headliner in FIG. 2. The section taken along line 3A-3A in direction T of the transverse-strength-weakened area 230 of the right side panel 122 of the vehicle headliner 100 in FIG. 2 may include a surface layer 334 and a substrate layer 332 supporting the surface layer 334, where the substrate layer 332 includes an outer sublayer 335 and an inner sublayer 336 positioned between the outer sublayer 335 and the surface layer 334 along a thickness direction. A cross-section of the outer sublayer 335 along the vehicle width direction W defines an edge portion 372 and a body portion 374 spaced apart from the edge portion 372 with a gap 350 there-between at the assembled position. There are no particular restrictions as to whether, how or where the outer sublayer 335 and inner sublayer 336 may be differentiated from each other as long as the inner sublayer 336 is generally positioned between the outer sublayer 335 and the surface layer 334. In another one or more embodiments, the inner sublayer 336 may not be differentiated at all from the outer sublayer 335, and may very well be merged into the outer sublayer 335.

In another one or more embodiments, at the assembled position, the gap 350 defines an outer gap 344 and an inner gap 342 positioned between the outer gap 344 and the surface layer 334 at the assembled position, the outer gap 344 being greater in gap dimension than the inner gap 342. The gap 350 may be of a depth smaller in value relative to the thickness of the substrate layer 332, and accordingly the substrate layer 332 is not completely severed in material at this location. This configuration with a V-shaped cut is believed to provide ample support for the sealing member, and to help lead the gas flow during an airbag deployment and then help protect the vehicle occupant from any negative impact due to the deployment. Moreover, and together with other guiding brackets, the edge portion 372 may provide leading and/or guiding of the gas flow and help deliver improved deployment performance of the side curtain airbag 180. The shape of the gap 350 may vary, such as being U or Y shaped, while the depth of the gap 350 such as the thickness along the direction T may be designed according to material strength of the substrate layer 332.

FIG. 3B illustratively depicts another view of the transverse-strength-weakened area 230. In this configuration, a cross-section along the thickness direction T along 3A-3A of the transverse-strength-weakened area 230 of the right side panel 122 of the vehicle headliner 100 includes a surface layer 334 and a substrate layer 352 supporting the surface layer 334. At an assembled position, a section of the substrate layer 352 along the width direction W defines an edge portion 382 and a body portion 392 spaced apart from the edge portion 382 with a gap 360. The gap 360 results from a complete severance of material at this location.

The gap 350 referenced in FIG. 3A is shown to be V-shaped, while the gap 360 referenced in FIG. 3B is shown to of a through aperture with certain dimension along the vehicle width direction W. These shapes may be realized by material removal and/or by injection molding in a mold with mold protrusions corresponding to the gap 360. In particular the V-shape of the gap 350 may be created via material removal optionally through knife-cutting or pressure punching. Alternatively, the V-shape of the gap 350 may be secondary to the effect of gravity imparted onto a knife-cut not necessarily with intentional material removal.

In another one or more embodiments, any suitable secondary forming solutions may be adopted to cut and/or punch the vehicle headliner 100 to form the transverse-strength-weakened area 230 and corresponding edges. In certain embodiments, the gap 360 may actually be formed via material removal while keeping surrounding parts relatively intact. Similarly the V-shape of the gap 350 may result from an intentional or unintentional bending after a knife-incision, not necessarily involving material removal.

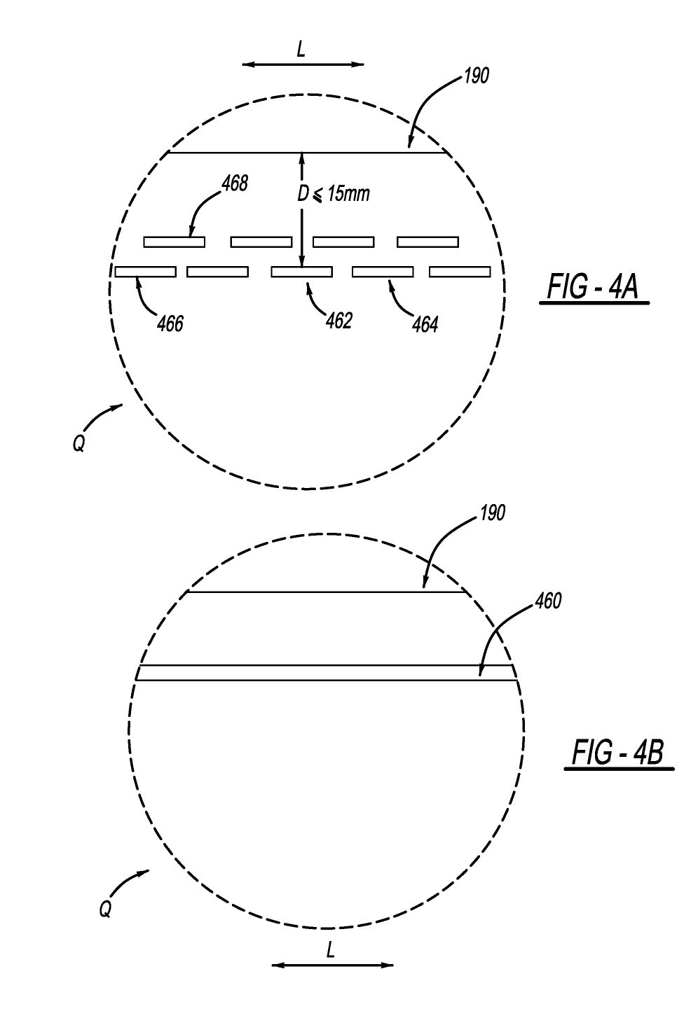

Referring back again to FIG. 2 and further in view of FIG. 4A-4B, which illustratively depicts a partially enlarged view of the area Q of the vehicle headliner 100 referenced in FIG. 2, the transverse-strength-weakened area 230 may include a first opening 462 and a second opening 464 spaced apart from each other along the longitudinal direction L, each of which may independently be of a cross-section as shown in FIG. 3A-3B. In certain embodiments, at least one of the first and second openings 462, 464 is spaced apart from the edge 190 of the right side panel 122 with a distance of no greater than 15 millimeters, or no greater than 10 millimeters so as to relatively ensure proper bending and/or breakage of the right side panel 122 to accommodate airbag deployment by providing desirable path clearance.

With the first and second openings 462, 464, transverse-strength of the corresponding area on the right side panel 122 of the headliner may be reduced to be suitable to permit proper gas movement during airbag deployment and accordingly to protect the vehicle occupant from unnecessary injuries associated with otherwise improper airbag deployment. With the airbag deployment thus properly carried out, there may not be any further requirement or need to impart additional restriction or limitation on the edge width of the edge of the vehicle headliner 100 along the direction W.

While the first and second openings 462, 464 are spaced apart or discontinuous from each other, the left and right side panels 122, 124 of the vehicle headliner 100 may be effectively weakened with the presence of the transverse-strength-weakened area 230, while maintaining structure integrity to support seating of the seal and avoid premature edge breakage of the vehicle headliner 100. It is appreciated that dimensions of the opening 462, 464 may be varied as desirable.

In yet another one or more embodiments, the transverse-strength-weakened area 230 referenced in FIG. 2 may include a third opening 466 and a fourth opening 468 spaced from each other along the vehicle width direction W and optionally be present in addition to or independently of the first and second openings 462, 464. The third and fourth openings 466, 468 do not have to be aligned to each other along the direction L and may be spaced apart along the direction L.

Similarly, the dimension of the third and fourth openings 466, 468 as well as their dimensions along in the longitudinal direction L and/or the width direction W may be varied as desirable. In certain instances, two or more transverse-strength-weakened areas may be present to effectuate targeted weakening in greater extent. When these transverse-strength-weakened areas are spaced apart from each other, there will be areas in-between and/or in the surrounds to accommodate attachment and connection to the seal.

In certain embodiments, at least one of the third and fourth openings 466, 468 is spaced apart from the edge 190 of the right side panel 122 with a distance of no greater than 15 millimeters, or no greater than 10 millimeters so as to relatively ensure proper breakage/bending of the right side panel 122 to accommodate airbag deployment. Again the left side panel 124 may adopt a similar configuration.

FIG. 4B illustratively depicts an alternative view of the embodiment referenced in FIG. 4A. Comparatively to FIG. 4A, the transverse-strength-weakened area 230 referenced in FIG. 4B may include an extended opening 460 instead of several spaced apart openings. The extended opening 460 may be of a cross-section similar to that depicted in FIG. 3A-3B. The depth of the extended opening 460 such as the thickness along direction T in FIG. 3A-3B may be smaller than the thickness of the substrate layer 334 so as to accommodate deployment of the side curtain airbag as well as to provide enough strength and avoid unwanted separation from the body portion of the vehicle headliner 100.

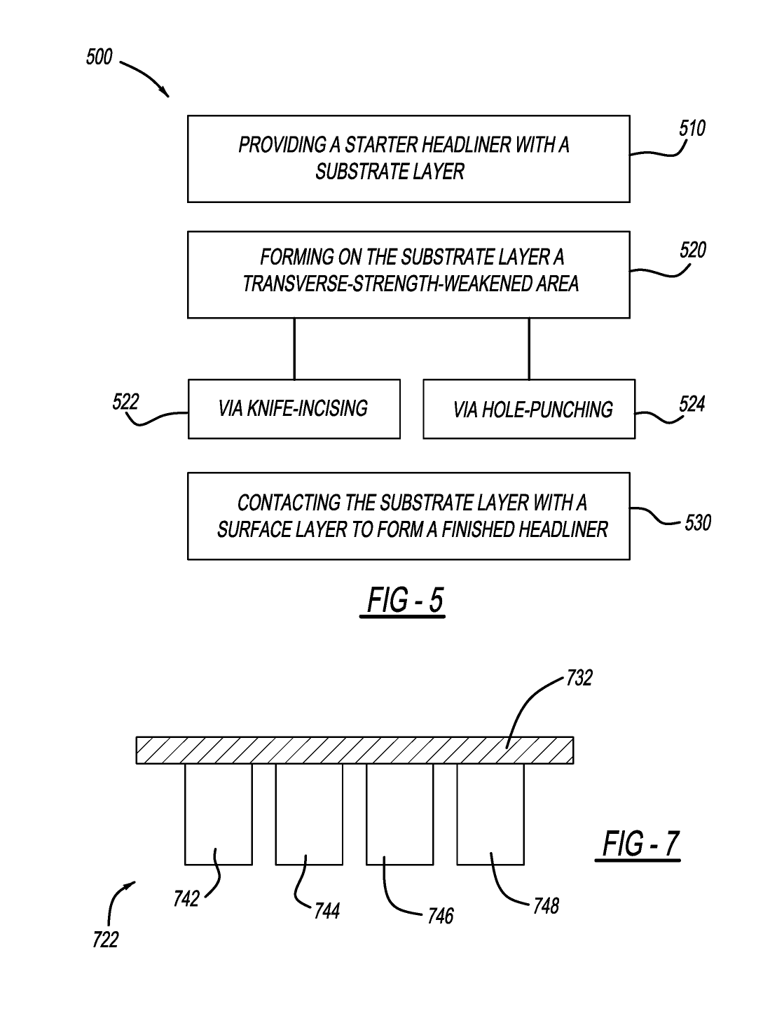

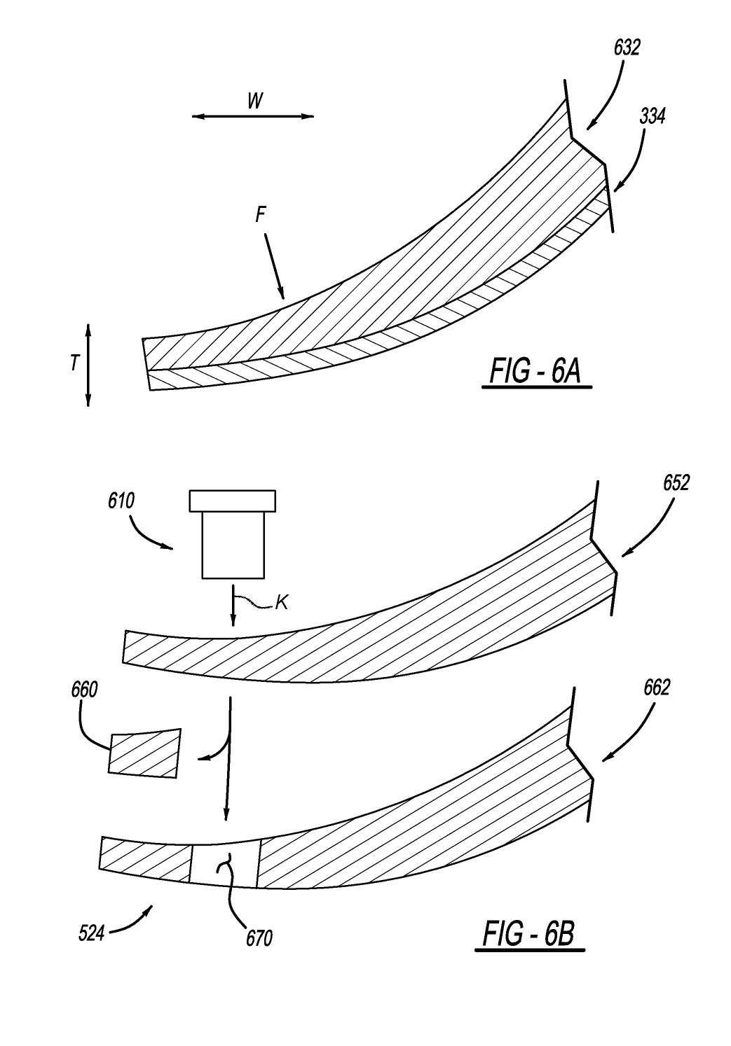

Features of the transverse-strength-weakened area 230 of the headliner are described in view of the illustrative drawings, formation of the vehicle headliner 100 with the transverse-strength-weakened area 230 referenced in FIG. 1 through FIG. 4B are described with reference to FIG. 5 and further in view of FIG. 6A and FIG. 6B. FIG. 5 illustratively depicts an exemplary method 500 of forming the vehicle headliner 100 referenced in FIG. 1 through FIG. 4B. At step 510, the method 500 includes providing a starter headliner (not shown) including a roof panel 110 positioned between left and right starter side panels (not shown) each of which includes a starter substrate layer 632, which may each independently be pre-formed to include one or more sublayers via any suitable methods. Non-limiting examples of materials that may be included in the starter substrate layer include foam, synthetic polymers, fabrics and glass fibers.

At step 520, a transverse-strength-weakened area such as the transverse-strength-weakened area 230 is formed on the starter substrate layer of at least one of the left and right starter side panels to form a left or right side panels 124, 122, the transverse-strength-weakened area 230 extends along the longitudinal direction L and to interface the vehicle pillar trim 170 at an assembled position. The transverse-strength-weakened area 230 may be formed via any suitable methods, for instance, processing the starter substrate layer 632 with at least one of knife-incising along direction F referenced at step 522 and further in view of FIG. 6A, and hole-punching referenced at step 524 to form the substrate layer 332 referenced in FIG. 3A.

In the embodiments referenced in FIG. 4A where spaced apart openings 466, 468, 464 and 462 are depicted, non-limiting forming techniques may include forming with a knifing tool having spaced apart blades or via a puncher having spaced apart punch heads. FIG. 7 illustratively depicts a non-limiting example side view of a knifing tool 722 that may be used to create the spaced apart openings 462, 464, 466 and/or 468 referenced in FIG. 4A. For instance, the knifing tool 722 may include a number of spaced apart blades such as blade 742, 744, 746, 748 supported on a handle 732 and with size dimensions respectively corresponding to the spaced apart openings such as openings 462, 464, 466 and/or 468 referenced in FIG. 4A. The shape and/or depth of the knife blades and/or the punching head may vary as necessary. In some embodiments, the transverse-strength-weakened area 230 may be formed on the substrate layer 332/352 via molding tools with corresponding protrusions.

The step 524 referenced in method 500 may further be detailed according to FIG. 6B, where a starter substrate layer 652 is subjected to hole-punching via a puncher 610 along direction K, and where a material portion 660 is removed to create a through opening 670 which may correspond to any of the openings 462, 464, 466, 468 referenced in FIG. 4A or the extended opening 460 referenced in FIG. 4B. With the removal of the material portion 660, an intermediate substrate layer 662 results. The hole-punching at step 524 is particularly beneficial in instances where sizable material removal may be desirable. In this particular design, the cover layer 334 may be attached to the intermediate substrate layer 662 to consequently form the right side panel 122 referenced in FIG. 1 and FIG. 3B.

After the step 520 at which the transverse-strength-weakened area 230 has been formed, method 500 may further include a step 530 of contacting the substrate layer 332, 352 with the surface layer 334. In certain embodiments, the step of contacting the substrate layer 332, 352 with the surface layer 334 may be carried out after the step 520 of forming the transverse-strength-weakened area 230. In another one or more embodiments, the surface layer 334 may already have been combined with the starter substrate layer at the step 510 thus no additional step 530 is required, accordingly the transverse-strength-weakened area 230 may be formed through one-step forming via suitable forming devices. The method of forming the vehicle headliner 100 has thus been described; however, it is noted that variations and modifications to the method are permissible without having to depart from the spirit of the disclosed method embodiments.

With reference to FIG. 1 through FIG. 5, a headliner and its forming method have been described. Such a headliner may be similarly introduced in technical areas other than a vehicle, such as areas involving airplanes and ships where a similar need for a transverse-strength-weakened area may be present.

The headliner embodiments disclosed herein are believed to have overcome certain challenges associated with vehicle headliner and airbag deployment. However, one skilled in the art will readily recognize from such discussion, and from the accompanying drawings and claims that various changes, modifications and variations can be made therein without departing from the true spirit and fair scope of the headliner and headliner restraint system as defined by the following claims.

What is claimed is:

1. A vehicle headliner, comprising:
a roof panel positioned between a left side panel and a right side panel, at least one of the left side panel and the right side panel including a transverse-strength-weakened area extending along a vehicle longitudinal direction and to interface a vehicle pillar along a vehicle width direction at an assembled position.

2. The vehicle headliner of claim 1, wherein the transverse-strength-weakened area includes a first opening and a second opening spaced apart from each other along the vehicle longitudinal direction.

3. The vehicle headliner of claim 2, wherein at least one of the first opening and the second opening is spaced apart from an edge of at least one of the left side panel and the right side panel with a distance of no greater than 15 millimeters.

4. The vehicle headliner of claim 2, wherein the transverse-strength-weakened area further includes a third opening and a fourth opening spaced apart from each other along the vehicle width direction.

5. The vehicle headliner of claim 4, wherein at least one of the third opening and the fourth opening is spaced apart from an end edge of the one of the left side panel and the right side panel with a distance of no greater than 15 millimeters.

6. The vehicle headliner of claim 1, wherein the transverse-strength-weakened area includes an extended opening extending along the vehicle longitudinal direction, the extended opening being greater in width than the vehicle pillar along the vehicle longitudinal direction.

7. The vehicle headliner of claim 1, wherein the transverse-strength-weakened area includes a surface layer and a substrate layer supporting the surface layer, the substrate layer including an outer sublayer and an inner sublayer positioned between the outer sublayer and the surface layer along a thickness direction, a cross-section of the outer sublayer along the width direction defines an edge portion and a body portion spaced apart from the edge portion with a gap there-between at the assembled position.

8. The vehicle headliner of claim 7, wherein the gap defines an outer gap and an inner gap positioned between the outer gap and the surface layer at the assembled position, the outer gap being greater in gap dimension than the inner gap.

9. A method of forming a vehicle headliner, the method comprising:
providing a starter headliner including a roof panel positioned between a left side panel and a right side panel with at least one of said left side panel and said right side panel including a substrate layer; and
forming a transverse-strength-weakened area on the substrate layer, the transverse-strength-weakened area extending along a vehicle longitudinal direction and to interface a vehicle pillar at an assembled position.

10. The method of claim 9, wherein the transverse-strength-weakened area is formed by subjecting the substrate layer to at least one of incising and hole-punching.

11. The method of claim 10, wherein the incising is carried out via a knife with spaced apart blades.

12. The method of claim 10, wherein the hole-punching is carried out via a puncher with spaced apart punch heads.

13. The method of claim 10, further comprising contacting the substrate layer with a surface layer.

14. The method of claim 13, wherein the contacting is subsequent to forming the transverse-strength-weakened area.

15. A vehicle headliner restraint system, comprising:
a headliner; and
a side curtain airbag at least partially positioned on the headliner, where the headliner includes a roof panel positioned between a left side panel and a right side panel, at least one of the left side panel and the right side panel including a transverse-strength-weakened area extending along a vehicle longitudinal direction and interfacing a vehicle pillar along a vehicle width direction of vehicle at an assembled position.

16. The vehicle headliner restraint system of claim 15, wherein the transverse-strength-weakened area includes a first opening and a second opening spaced apart from each other along the vehicle longitudinal direction.

17. The vehicle headliner restraint system of claim 16, wherein the transverse-strength-weakened area further includes a third opening and a fourth opening spaced apart from each other along the vehicle width direction.

18. The vehicle headliner restraint system of claim 15, wherein the transverse-strength-weakened area includes an extended opening extending along the vehicle longitudinal direction, the extended opening being greater in width than the vehicle pillar along the vehicle longitudinal direction.

19. The vehicle headliner restraint system of claim 15, wherein the transverse-strength-weakened area includes a surface layer and a substrate layer supporting the surface layer, the substrate layer including an outer sublayer and an inner sublayer positioned between the outer sublayer and the surface layer along a thickness direction, a cross-section of the outer sublayer along the width direction defines an edge portion and a body portion spaced apart from the edge portion with a gap there-between at the assembled position.

20. The vehicle headliner restraint system of claim 19, wherein the gap defines an outer gap and an inner gap positioned between the outer gap and the surface layer at the assembled position, the outer gap being greater in gap dimension than the inner gap.
